(19) United States
(12) Patent Application Publication
(10) Pub. No.: US 2014/0289432 A1
(43) Pub. Date: Sep. 25, 2014

(54) CONNECTING DEVICE OF THE TRANSPORT SCREEN

(71) Applicant: Chia-Hao Lin, Taipei (TW)

(72) Inventor: Chia-Hao Lin, Taipei (TW)

(21) Appl. No.: 14/219,063

(22) Filed: Mar. 19, 2014

(30) Foreign Application Priority Data
Mar. 19, 2013 (TW) 102204951

(51) Int. Cl. G06F 3/14

(52) U.S. Cl. CPC G06F 3/1407
USPC 710/72

(57) ABSTRACT

The present invention relates to a connecting device of the transport screen, comprising: A connecting unit, with one or more electrical sockets for the I/O of the portable device to be connected; and a data transferring and controlling unit, one side of the unit could be connected to said connecting unit and the other side could be connected to the transport screen, so that the screen signal of the portable device could be transferred to one or more transport screen, if the transport screen, the touch signal also could be transferred to the portable device.

### BACKGROUND OF THE INVENTION

1. Field of the Invention

The present invention relates to a connecting device, particularly it pertains to a connecting device that the screen signal of the portable device could be transferred to one or more transport screen, if the transport screen, the touch signal also could be transferred to the portable device.

2. Description of the Related Art

With the growing popularity of science and technology, Cars have become the indispensable means of transport.

Transport vehicle is currently configured with display screen. The main function of the display screen only accepts video signals. The passengers or the drivers still obtain information or play game by portable devices.

After all, the screen of the portable device is too small and is needed to bow to operate. It is very dangerous and affecting vision. How to integrate with the transport screen is a creative problem to be solved.

### SUMMARY OF THE INVENTION

The inventor of the present invention has spent years researching and developing a connecting device to integrate with the transport screen.

The present invention relates to a connecting device of the transport screen, comprising: A connecting unit, with one or more electrical sockets for the I/O of the portable device to be connected; and a data transferring and controlling unit, one side of the unit could be connected to said connecting unit and the other side could be connected to the transport screen.

The main aim of the present invention is to provide a connecting device that the screen signal of the portable device could be transferred to one or more transport screen.

### BRIEF DESCRIPTION OF THE DRAWINGS

FIG. 1 is a schematic diagram showing the embodiment of the present invention.

### DETAILED DESCRIPTION OF THE PREFERRED EMBODIMENT

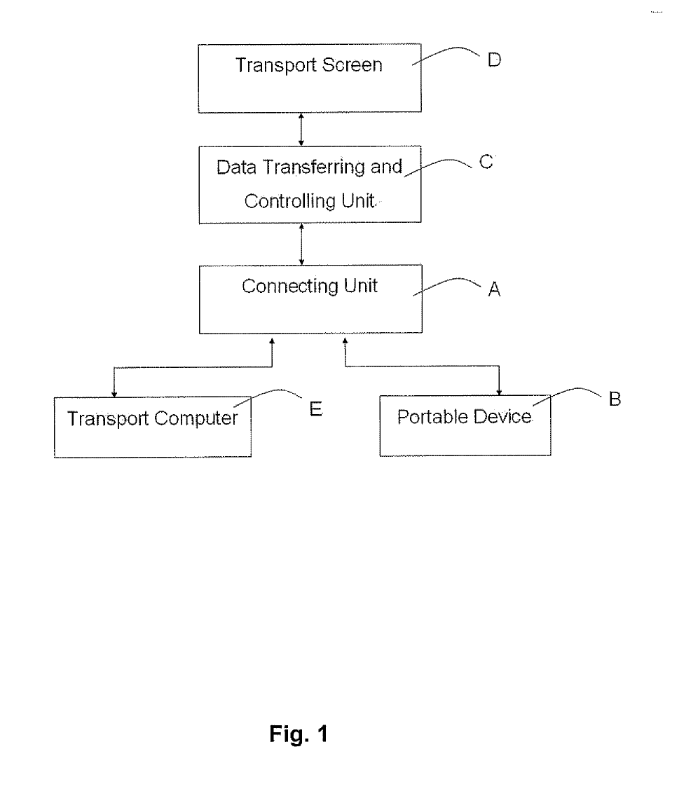

Please refer to FIG. 1, FIG. 1 is schematic diagram showing the embodiment of the present invention. The present invention relates to a connecting device of the transport screen, comprising: A connecting unit A, with one or more electrical sockets for the I/O of the portable device to be connected; and a data transferring and controlling unit C, one side of the unit could be connected to said connecting unit A and the other side could be connected to the transport screen (the screen used in the transport) D, so that the screen signal of the portable device B could be transferred to one or more transport screen D, if the transport screen, the touch signal also could be transferred to the portable device B.

Said connecting unit A could be connected to the audio equipment of the transport, so that the audio signal of the portable device B could be transferred to the audio equipment of the transport.

Said connecting unit A could be integrated with the body of transport or be integrated with the equipment of the transport.

Said connecting unit A could be set with one or more signal connectors or sockets for support many kinds of the portable devices B and transport computers E, or could offer one or more signal connectors or sockets for support many kinds of the portable devices B and transport computers E.

Said screen signal could be combined with the screen signal of the portable device B and the current screen signal of the transport screen D.

The files of said transport screen D could be transferred to or could be shared with the portable device by data transferring and controlling unit C, the screen signal of said transport screen D could be transmitted to the portable device B by data transferring and controlling unit C, and the screen signal of said transport screen D could be transmitted to cloud system by the wireless module of the portable device B.

The screen signal transmitted from the portable device to said transport screen D could be keep on the horizontal state or keep on the screen saver mode by an app installed on the portable device A or by the firmware installed on the data transferring and controlling unit C.

It is worth to mention that wherein said connecting unit A could be controlled to choose the source of the screen signal by hardware, firmware or software.

As is understood by a person skilled in the art, the foregoing preferred embodiment of the present invention is an illustration, rather than a limiting description of the present invention, It is intended to cover various modifications and similar arrangements. all the may vary and should be considered within the spirit and scope of the appended claims of the present invention. In short, the spirit and scope should be accorded the broadest interpretation so as to encompass all such modifications and similar structures.

What is claimed:

1. The connecting device of the transport screen, comprising:
A connecting unit, with one or more electrical sockets for the I/O of the portable device to be connected; and
A data transferring and controlling unit, one side of the unit could be connected to said connecting unit and the other side could be connected to the transport screen, so that the screen signal of the portable device could be transferred to one or more transport screen, if the transport screen, the touch signal also could be transferred to the portable device.

2. The connecting device of the transport screen as in claim 1, wherein said connecting unit could be connected to the audio equipment of the transport, so that the audio signal of the portable device could be transferred to the audio equipment of the transport.

3. The connecting device of the transport screen as in claim 1, wherein said connecting unit could be integrated with the body of transport or be integrated with the equipment of the transport.

4. The connecting device of the transport screen as in claim 1, claim 2 or claim 3, wherein said connecting unit could be set with one or more signal connectors or sockets for support many kinds of the portable devices and transport computers, or could offer one or more signal connectors or sockets for support many kinds of the portable devices and transport computers.

5. The connecting device of the transport screen as in claim 1, claim 2 or claim 3, wherein said screen signal could be combined with the screen signal of the portable device and the current screen signal of the transport screen.

6. The connecting device of the transport screen as in claim 1, claim 2 or claim 3, wherein the files of said transport screen could be transferred to or could be shared with the portable device by data transferring and controlling unit, the screen signal of said transport screen could be transmitted to the portable device by data transferring and controlling unit, and the screen signal of said transport screen could be transmitted to cloud system by the wireless module of the portable device.

7. The connecting device of the transport screen as in claim 1, claim 2 or claim 3, wherein the screen signal transmitted from the portable device to said transport screen could be keep on the horizontal state or keep on the screen saver mode by an app installed on the portable device or by the firmware installed on the data transferring and controlling unit.

8. The connecting device of the transport screen as in claim 1, claim 2 or claim 3, wherein said connecting unit could be controlled to choose the source of the screen signal by hardware, firmware or software.
